(19) United States
(12) Patent Application Publication
(10) Pub. No.: US 2026/0084551 A1
(43) Pub. Date: Mar. 26, 2026

(54) Adapter and charging system

(71) Applicant: HON HAI PRECISION INDUSTRY CO., LTD., New Taipei (TW)

(72) Inventors: CHIH-CHENG LEE, New Taipei (TW); JYUN-LIN JIANG, New Taipei (TW); CHIH-TE HUNG, New Taipei (TW); YU-CHENG ZHANG, New Taipei (TW); CHIUNG-HSIANG WU, New Taipei (TW); YI-LUN WEI, New Taipei (TW); CHUNG-WEI LU, New Taipei (TW); CHEN-TING KAO, New Taipei (TW); SHENG-LI YEN, New Taipei (TW); CHEN CHAO, New Taipei (TW); CHENG-HUNG CHEN, New Taipei (TW); CHI-LIN WU, New Taipei (TW); HSIU-HAO CHENG, New Taipei (TW); KAI FAN CHIANG, New Taipei (TW); CHIH-HAO KUO, New Taipei (TW)

(21) Appl. No.: 18/918,282

(22) Filed: Oct. 17, 2024

(30) Foreign Application Priority Data
Sep. 20, 2024 (CN) 202411318682.0

(51) Int. Cl. B60L 53/16; H01R 13/629; H01R 31/06

(52) U.S. Cl. CPC B60L 53/16; H01R 13/629; H01R 31/06

(57) ABSTRACT

An adapter and a charging system, the adapter includes a housing, a locking assembly and a transmission assembly. The housing is provided with a mounting cavity for mounting a charging gun. The locking assembly is movably disposed in the housing and has a first locking state capable of locking the charging gun in the mounting cavity, and a first unlocking state capable of unlocking the charging gun from the mounting cavity. The transmission assembly is movably disposed in the housing and is capable of engaging the locking assembly to limit the locking assembly to the first locked state. The transmission assembly is constructed to be capable of pushing the locking assembly when the charging gun is extended into the mounting cavity, driven by the charging gun, to switch the locking assembly from the first unlocked state to the first locked state.

### FIELD

The subject matter relates to the technical field of charging adapter devices, and in particular to adapter and charging system.

### BACKGROUND

An adapter is provided in the related art, wherein when the standard of the charging gun is different from the standard of the charging interface of the vehicle, the charging gun is mounted on the adapter and connected to the charging interface of the vehicle through the adapter.

However, the adapter in the related technology requires a locking mechanism to be provided on the outside of the charging gun to lock the charging gun with the adapter, so when the charging gun needs to be locked to the adapter, the locking mechanism which is located on the outside of the adapter needs to be operated. Operating the locking mechanism may be inconvenient for the user.

### SUMMARY

The present application provides adapters and charging systems to solve the problem of how to make the adapters and charging guns easy to lock.

According to an aspect of the present application, the adapter includes a housing, a locking assembly and a transmission assembly. The housing is provided with a mounting cavity, the mounting cavity is configured for mounting a charging gun. The locking assembly is movably disposed in the housing, the locking assembly has a first locking state capable of locking the charging gun in the mounting cavity, and a first unlocking state capable of unlocking the charging gun from the mounting cavity. The transmission assembly is movably disposed in the housing, the transmission assembly is configured for engaging the locking assembly when the locking assembly in the first locked state. When the charging gun is extended into the mounting cavity, the drive assembly is drivable by the charging gun to push the locking assembly to switch the locking assembly from the first unlocked state to the first locked state.

With the above-described adapter, when the charging gun is extended into the mounting cavity, the charging gun drives the transmission assembly, so that the transmission assembly drives the locking assembly to switch from the first unlocking state to the first locking state, locking the charging gun in the mounting cavity, thereby eliminating the need to add a locking mechanism outside the adapter and operate it, and thus improving the ease of operation when locking the charging gun with the adapter.

In one embodiment, the transmission assembly includes a first transmission wheel set, a first rack and a second rack. The first drive wheel set includes a first transmission shaft, a first ratchet and a first gear, the first transmission shaft is rotationally connected to the housing around a first axis of rotation along a first direction, the first ratchet is socketed at an end of the first transmission shaft, and the first gear is socketed at another end of the first transmission shaft. The first rack and the second rack are located on opposite sides of the first axis of rotation and are movably disposed in the housing along a second direction, the second direction is perpendicular to the first direction. The first rack engages the first ratchet. The second rack engages the first gear and is configured for engaging the locking assembly along the second direction to push the locking assembly to switch from the first unlocked state to the first locked state. When the charging gun is extended into the mounting cavity, the charging gun is configured for driving the first rack away from the mounting cavity along the second direction and driving the first ratchet to rotate about the first axis of rotation, causing the first gear to drive the second rack closer to the mounting cavity along the second direction, thereby driving the locking assembly to switch from the first unlocked state to the first locked state.

In one embodiment, the locking assembly includes a slider and a first locking part. The slider is movably extended in the housing along the second direction; the second rack is configured for abutting the slider in the second direction, so that when the charging gun is extended into the mounting cavity, the second rack is configured for pushing the slider closer to the mounting cavity along the second direction; the slider is provided with a first beveled surface on an end of the slider away from the second rack, the first beveled surface is parallel to the first direction, an angle between the first beveled surface and the second direction is an acute angle. The first locking part extends movably in the housing along a third direction, the first locking part is provided with a second beveled surface at an end along the third direction, the second beveled surface cooperates with the first beveled surface, and the first locking part is extendable into the mounting cavity at an end of the first locking part that is away from the second beveled surface along the third direction, so as to lock the charging gun inside the mounting cavity, the third direction is perpendicular to the first direction and the second direction. When the charging gun is extended into the mounting cavity, the slider is configured for driving the first locking part along the third direction into the mounting cavity to limit the charging gun to the first locking state.

In one embodiment, the locking assembly further includes a fixing bracket and a first elastic member. The slider is connected to the stationary bracket along a side of the third direction proximate to the mounting cavity, the slider is movable relative to the stationary bracket along the second direction, and the slider is provided with an operation portion on a side of the slider along the third direction away from the mounting cavity, the operation portion is exposed to the housing. The first elastic member is disposed between the first locking part and the fixing bracket, the first elastic member is in contact with the first locking part and the fixing bracket respectively, and configured for exerting an elastic force on the first locking part in the third direction away from the mounting cavity.

In one embodiment, the transmission assembly further includes a second transmission wheel set and a third rack. The second transmission wheel set includes a second transmission shaft, a second gear and a second ratchet, the second transmission shaft is rotationally connected to the housing around a second axis of rotation, the second axis of rotation is parallel to and spaced apart from the first axis of rotation, the second gear is provided at an end of the second transmission shaft and meshing with the second rack; the second ratchet is provided at an end of the second transmission shaft away from the second gear. The third rack and the second rack are located on different sides of the second axis of rotation, the third rack engages the second ratchet. When the adapter is coupled to a base, the base is configured for driving the third rack to be brought proximate to the mounting cavity, and driving the second ratchet to rotate about the second axis of rotation, for causing the second gear to drive the second rack away from the locking assembly along the second direction, thereby causing the locking assembly to be switchable from the first locking state to the first unlocking state.

In one embodiment, the adapter further includes a second locking part, the second locking part is movably connected to the housing, the second locking part has a second locked state and a second unlocked state, the second locking part is locked with the base in the second locked state, and the second locking part is unlocked with the base in the second unlocked state. The transmission assembly further includes a fourth rack, the fourth rack engages the first gear, the fourth rack is configured for engaging the second locking part thereby placing the second locking part in the second locking state. When the adapter is connected to the base, the base is configured for driving the third rack closer to the mounting cavity, and driving the second ratchet around the second axis of rotation, so that the second gear drives the second rack away from the locking component along the second direction, thereby causing the second rack to drive the first gear to rotate, causing the first gear to drive the fourth rack toward a side of the locking component closer to the second locking part side, to move the second locking part in the second locking state.

In one embodiment, the second locking part switches between the second locking state and the second unlocking state by rotating about a third axis of rotation relative to the housing, the third axis of rotation is parallel and spaced apart from the first axis of rotation. The second locking part includes a first end and a second end, the first end and the second end are located on respective sides of the third axis of rotation; the first end locks the base. In the second locking state, the second end is held against the fourth rack so that the first end locks the base.

In one embodiment, the mounting cavity extends along the second direction and through an end of the adapter to form an opening. An end of the housing away from the opening is provided with a connection portion, the connection portion is connectable to the base.

In one embodiment, the housing includes a first portion and a second portion, the first portion is provided with the opening at an end along the second direction. An end of the second portion is connected to an end of the first portion away from the opening, another end of the second portion is provided with the connection portion, and the second portion extends in a fourth direction, the fourth direction is perpendicular to the first direction, an angle between the fourth direction and the second direction is an acute angle. The third rack is movably disposed through the housing in the fourth direction.

According to another aspect of the present application, there is provided a charging system includes a charging gun, a base and an adapter as described in any of the above embodiments, the adapter is capable of being mounted to a base.

### BRIEF DESCRIPTION OF THE DRAWINGS

FIG. 1 shows a schematic view of a structure of a charging system in an embodiment according to the present disclosure.

FIG. 2 shows a schematic view of an assembled state of a charging gun and an adapter in the embodiment shown in FIG. 1.

FIG. 3 shows a schematic view of the assembled state of a base and the adapter in the embodiment shown in FIG. 1.

FIG. 4 shows a schematic view of a structure of the adapter in the embodiment shown in FIG. 1.

FIG. 5 shows a side view of the adapter in the embodiment shown in FIG. 1.

FIG. 6 shows a schematic view of the structure of the adapter in the embodiment shown in FIG. 1 in another view.

FIG. 7 shows a schematic view of a structure of a drive assembly in the embodiment shown in FIG. 1.

FIG. 8 shows a schematic view of a portion of the structure of the adapter in the embodiment shown in FIG. 1 in a first unlocked state.

FIG. 9 shows a schematic view of a portion of the structure of the adapter in the embodiment shown in FIG. 1 in a first locked state.

FIG. 10 shows a three-dimensional view of the locking assembly of the embodiment shown in FIG. 1.

FIG. 11 shows a schematic view of a portion of the structure of the charging gun and the adapter of the embodiment shown in FIG. 1 in another view.

### DETAILED DESCRIPTION

The technical solutions in the embodiments of the present application will be described clearly and completely in the following in conjunction with the accompanying drawings in the embodiments of the present application, and it is clear that the described embodiments are only a part of the embodiments of the present application and not all of the embodiments.

It should be noted that when an element is the to be “fixed” to another element, it may be directly on the other element or there may also be a centered element. When an element is the to be “attached” to another element, it may be directly attached to the other element or there may be both centered elements. When an element is considered to be “set on” another element, it may be set directly on the other element or there may be both centered elements. The terms “vertical,” “horizontal,” “left,” “right,” and similar expressions are used herein for illustrative purposes only. are used herein for illustrative purposes only.

Unless otherwise defined, all technical and scientific terms used herein have the same meaning as commonly understood by those skilled in the art belonging to the field of this application. Terms used herein in the specification of this application are used only for the purpose of describing specific embodiments and are not intended to limit this application. The term “or/and” as used herein includes any and all combinations of one or more related listed items.

Some embodiments of the present application are described in detail. The following embodiments and features in the embodiments may be combined with each other without conflict.

### Example of Implementation

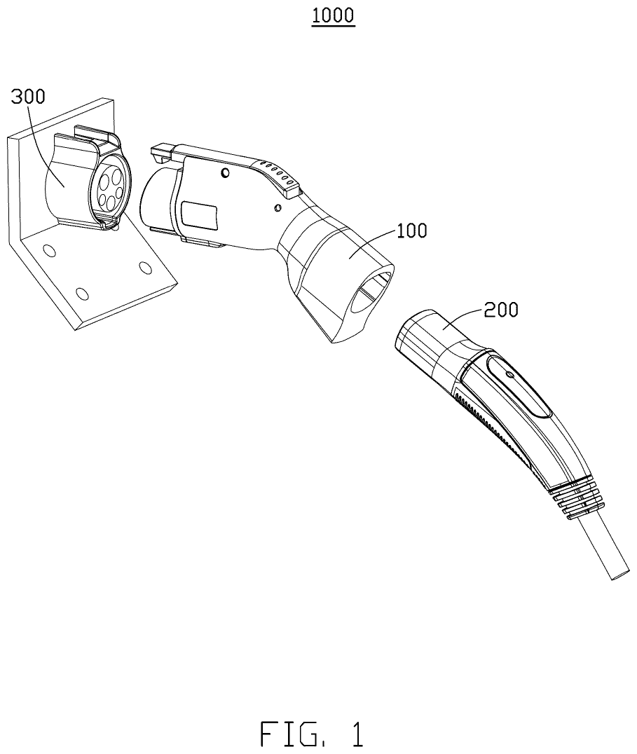

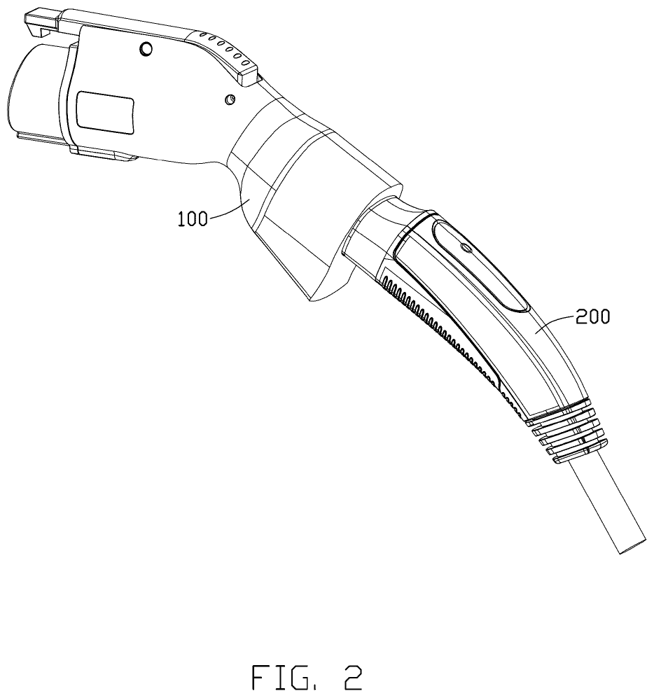

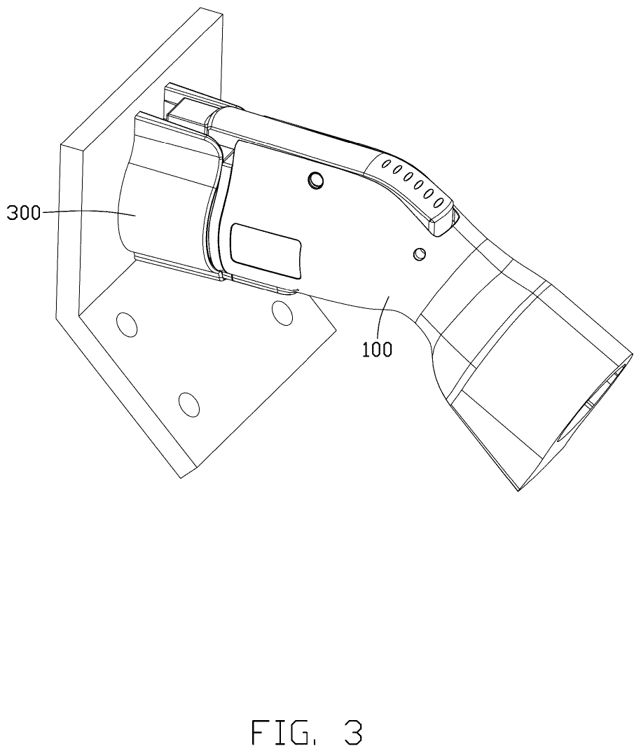

FIG. 1 shows a schematic view of the structure of the charging system 1000 in an embodiment of the present application; FIG. 2 shows a schematic view of the assembly state of the charging gun 200 and the adapter 100 in the embodiment shown in FIG. 1; FIG. 3 shows a schematic view of the assembly state of the base 300 and the adapter 100 in the embodiment shown in FIG. 1.

Referring to FIG. 1, embodiments of the present application provide a charging system 1000 for charging a vehicle. The vehicle is, for example, an electric vehicle, a plug-in hybrid vehicle, or the like. In some embodiments, the vehicle may also be an electric motorcycle or other vehicle capable of being charged.

The charging system 1000 includes a charging gun 200, a base 300, and an adapter 100, the adapter 100 is capable of being mounted to the base 300.

When the charging gun 200 has the same standard as the charging interface (not shown in the figure) of the vehicle, the charging gun 200 may be directly employed to plug into the charging interface to charge the vehicle. As shown in FIG. 2, when the charging gun 200 and the charging interface of the vehicle have different standards, the charging gun 200 may be connected to the adapter 100 so that the charging gun 200 is connected to the charging interface of the vehicle via the adapter 100 to charge the vehicle.

As shown in FIG. 3, when the adapter 100 is not used, the adapter 100 can be stored in the base 300 so that the adapter 100 is not easily lost.

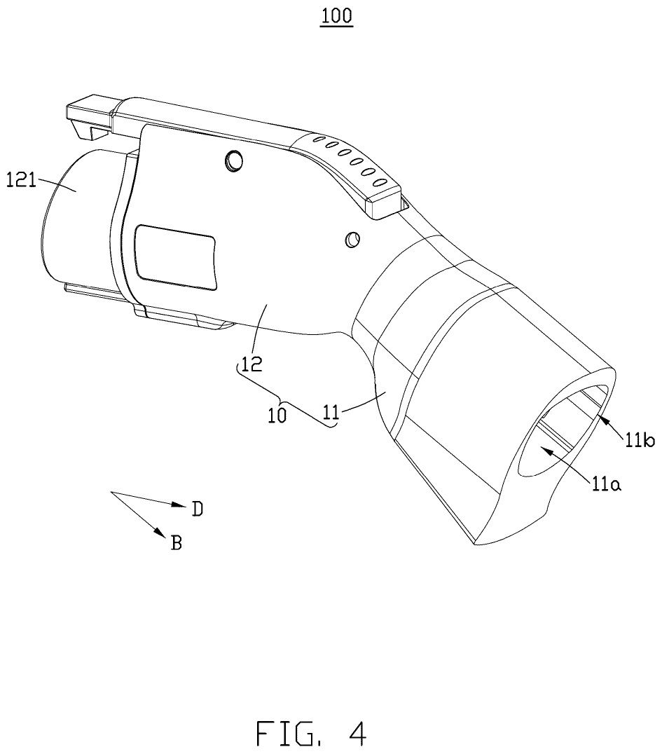

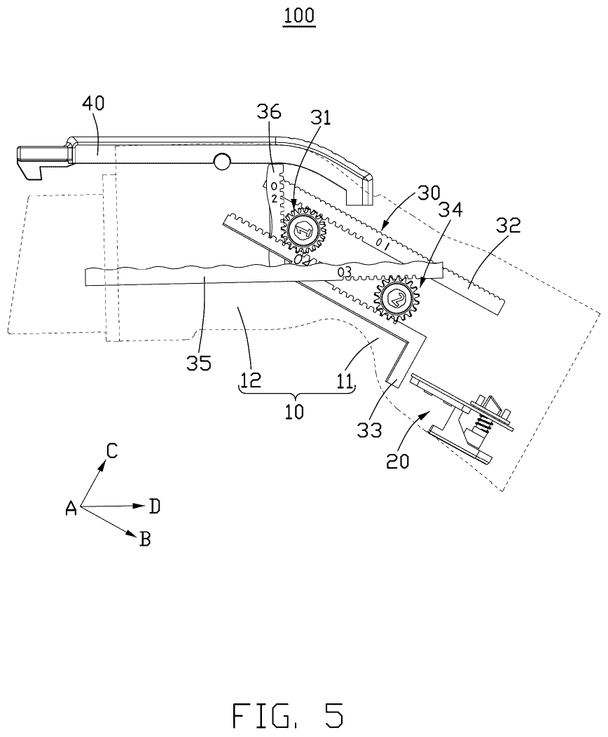

FIG. 4 shows a schematic view of the structure of the adapter 100 in the embodiment shown in FIG. 1; FIG. 5 shows a side view of the adapter 100 in the embodiment shown in FIG. 1.

Referring to FIG. 4 and FIG. 5, the adapter 100 in this embodiment includes a housing 10, a locking assembly 20 and a transmission assembly 30. The housing 10 is provided with a mounting cavity 11a, the mounting cavity 11a is used to mount a charging gun 200 (see FIG. 1). The locking assembly 20 is movably disposed in the housing 10. The locking assembly 20 has a first locking state and a first unlocking state; in the first locking state, the charging gun 200 is locked within the mounting cavity 11a; and in the first unlocking state, the charging gun 200 is not locked within the mounting cavity 11a. The transmission assembly 30 is movably disposed in the housing 10, and the transmission assembly 30 is capable of being pressed against the locking assembly 20 for placing the locking assembly 20 in the first locked state. When the charging gun 200 is extended into the mounting cavity 11a, the charging gun 200 is able to drive the transmission assembly 30 to push the locking assembly 20, causing the locking assembly 20 to switch from the first unlocked state to the first locked state.

The above-described adapter 100, when in use, when the charging gun 200 is extended into the mounting cavity 11a, the charging gun 200 is able to drive the transmission assembly 30. The transmission assembly 30 drives the locking assembly 20 to switch from the first unlocking state to the first locking state, so as to lock the charging gun 200 in the mounting cavity 11a. This reduces the risk of theft when the adapter 100 is connected to the charging gun 200, and eliminates the need to install an additional locking mechanism (not shown) for locking the charging gun 200 outside the adapter 100. When the charging gun 200 is connected to the adapter 100, locking is achieved by inserting the charging gun 200 into the mounting cavity 11a. This eliminates the need to operate the locking mechanism (e. g., entering a code or inserting a key, etc.), making the operation of locking the charging gun 200 with the adapter 100 simpler and easier to use.

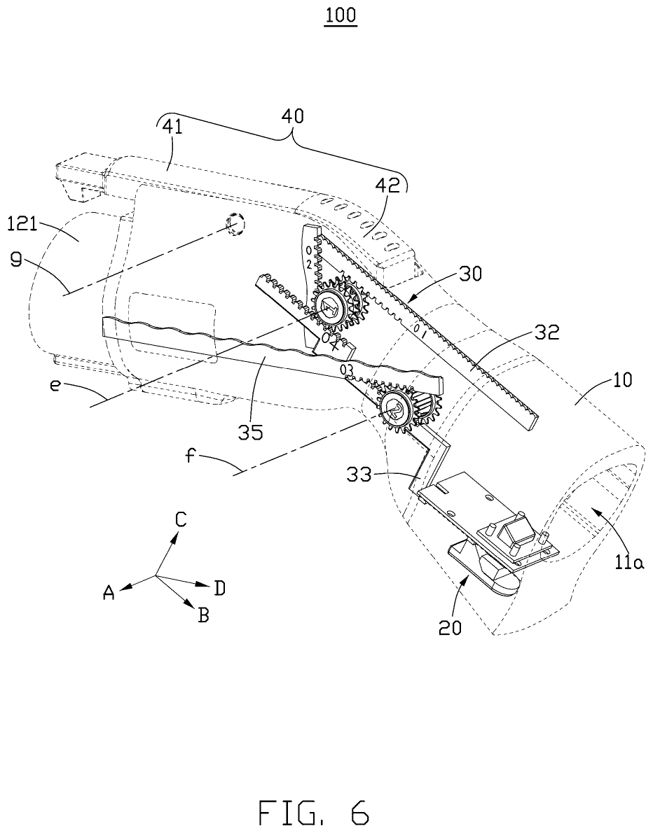

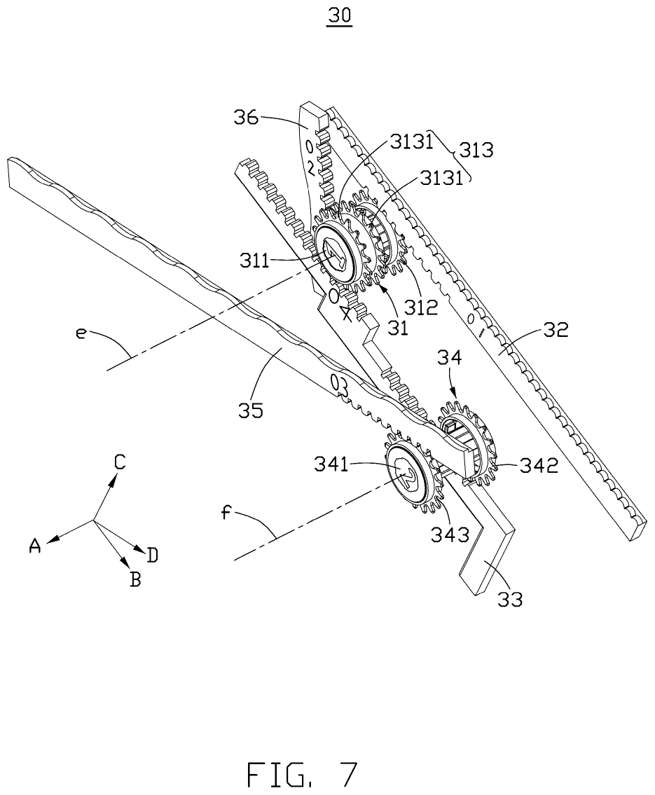

FIG. 6 shows a schematic view of the structure of the adapter 100 in the embodiment shown in FIG. 1 in another view; and FIG. 7 shows a schematic view of the structure of the transmission assembly 30 in the embodiment shown in FIG. 1.

In some embodiments, as shown in FIGS. 5 to 7, the transmission assembly 30 includes a first transmission wheelset 31, a first rack 32 and a second rack 33. The first transmission wheelset 31 includes a first transmission shaft 311, a first ratchet 312, and a first gear 313. The first transmission shaft 311 is rotationally coupled to the housing 10 around a first axis of rotation e, with the first axis of rotation e along a first direction A. The first gear 313 is disposed at one end of the first transmission shaft 311, and the first gear 313 is disposed at the other end. The first ratchet 312 is set on one end of the first transmission shaft 311, and the first gear 313 is set on the other end of the first transmission shaft 311. The first rack 32 and the second rack 33 are disposed on opposite sides of the first axis of rotation e, respectively. The first rack 32 and the second rack 33 are both movably extended from the housing 10 along a second direction B. The second direction B is perpendicular to the first direction A. The first rack 32 engages with the first ratchet 312, the second rack 33 engages with the first gear 313, the second rack 33 is capable of engaging the locking assembly 20 along the second direction B to push the locking assembly 20 to switch from the first unlocked state to the first locked state. When the charging gun 200 is extended into the mounting cavity 11a, the charging gun 200 is able to drive the first rack 32 away from the mounting cavity 11a along the second direction B and drive the first ratchet 312 to rotate around the first axis of rotation e, so as to cause the first gear 313 to drive the second rack 33 closer to the mounting cavity 11a along the second direction B to drive the locking assembly 20 to switch from the first unlocked state to the first locked state.

In this way, when the charging gun 200 is extended into the mounting cavity 11a, the charging gun 200 pushes the first rack 32 away from the mounting cavity 11a in the second direction B, so that the first rack 32 drives the first transmission shaft 311 to rotate through the first ratchet 312, so that the first gear 313 is driven to rotate by the first transmission shaft 311, which then drives the second rack 33 to be close to the mounting cavity 11a through the first gear 313, to drive the locking assembly 20 to lock the charging gun 200 in the mounting cavity 11a. The first rack 32 and the second rack 33 are located on opposite sides of the first axis of rotation e. When the first ratchet 312 and the first gear 313 are rotated in the same direction (e. g., counterclockwise as shown in FIG. 5), the second rack 33 is moved towards the side opposite to the first rack 32, so that the second rack 33 pushes the locking assembly 20 in the second direction B towards the side close to the mounting cavity 11a, thereby cause the locking assembly 20 to switch to the first locking state, locking the charging gun 200 in the mounting cavity 11a.

In some embodiments, the transmission assembly 30 further includes a first reset member (not shown in the figures), the first reset member (e. g., a spring) includes an elastic material. The first reset member resiliently rests against between the first rack 32 and the housing 10 to apply an elastic force to the first rack 32 along the second direction B toward the side proximate the mounting cavity 11a. So that after the charging gun 200 is removed from the mounting cavity 11a, the first rack 32 is reset toward the side proximate the mounting cavity 11a by the elastic force of the elastic member.

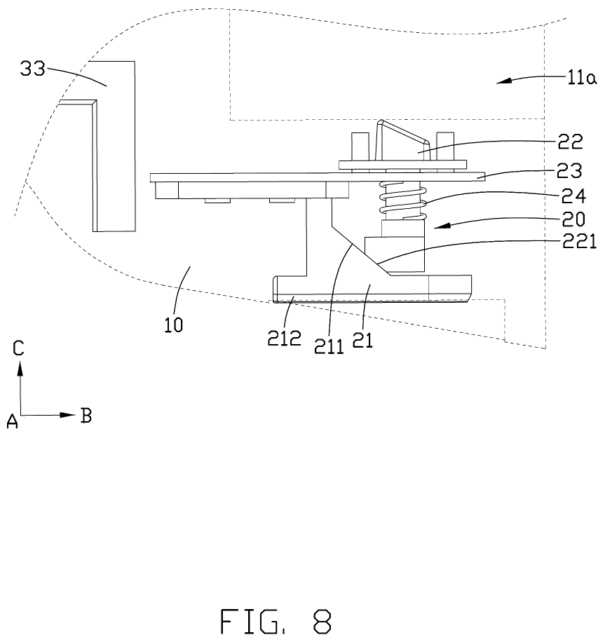

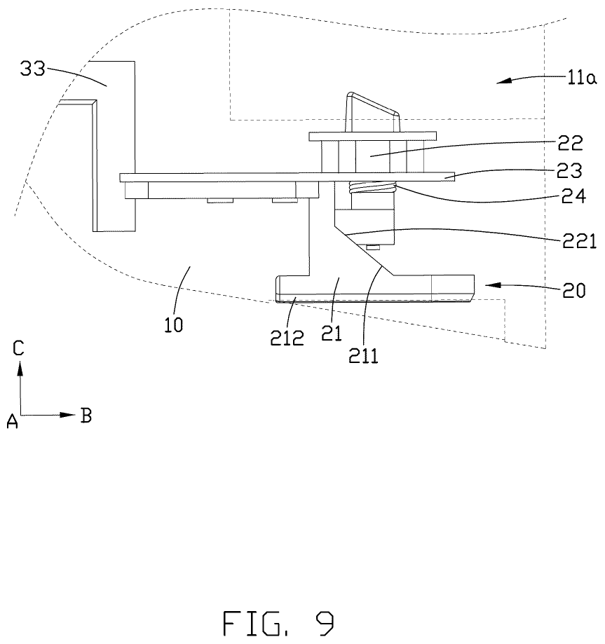

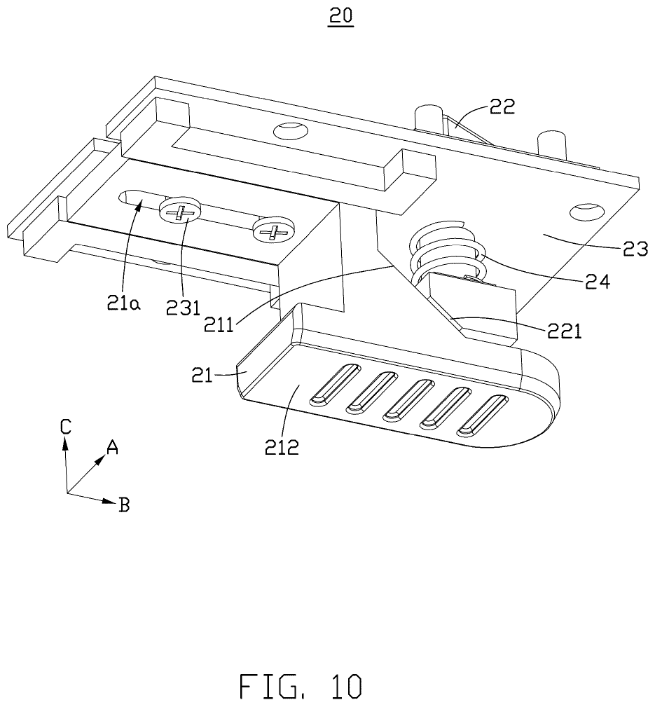

FIG. 8 shows a schematic view of a portion of the structure of the adapter 100 in the embodiment shown in FIG. 1 in a first unlocked state; FIG. 9 shows a schematic view of a portion of the structure of the adapter 100 in the embodiment shown in FIG. 1 in a first locked state; and FIG. 10 shows a three-dimensional view of the locking assembly 20 in the embodiment shown in FIG. 1.

In some embodiments, as shown in FIG. 8, the locking assembly 20 includes a slider 21 and a first locking part 22. The slider 21 is movably extendable from the housing 10 along a second direction B. The second rack 33 is capable of abutting the slider 21 along the second direction B. So that, when the charging gun 200 (see FIG. 2) is extended into the mounting cavity 11a, the second rack 33 can propel the slider 21 in the second direction B closer to the mounting cavity. The slider 21 is provided with a first beveled surface 211 at the end of the slider 21 away from the second rack 33, the first beveled surface 211 is parallel to the first direction A. The first beveled surface 211 is parallel to the first direction A. The angle between the first beveled surface 211 and the second direction B is an acute angle. The first locking part 22 is movably extended to the housing 10 along the third direction C. One end of the first locking part 22 along the third direction C is provided with a second beveled surface 221. The second beveled surface 221 cooperates with the first beveled surface 211. The end of the first locking part 22 along the third direction C away from the second beveled surface 221 is capable of extending into the mounting cavity 11a to lock the charging gun 200 within the mounting cavity 11a. The third direction C is perpendicular to the first direction A and the second direction B, respectively. When the charging gun 200 is extended into the mounting cavity 11a, the slider 21 is able to drive the first locking part 22 to extend into the mounting cavity 11a along the third direction C to limit the charging gun 200 to the first locking state.

When the charging gun 200 is extended into the mounting cavity 11a, the second rack 33 pushes the slider 21 along the second direction B. By cooperating the first beveled surface 211 with the second beveled surface 221, the slider 21 pushes the first locking part 22 to extend into the mounting cavity 11a along the third direction C, thereby locking the charging gun 200 in the mounting cavity 11a.

In the above embodiment, since the transmission assembly 30 and the locking assembly 20 are mechanically locked with the charging gun 200 and the adapter 100, respectively, the adapter 100 itself can be used without charging, thereby reducing the limitation on the use scenarios of the adapter 100.

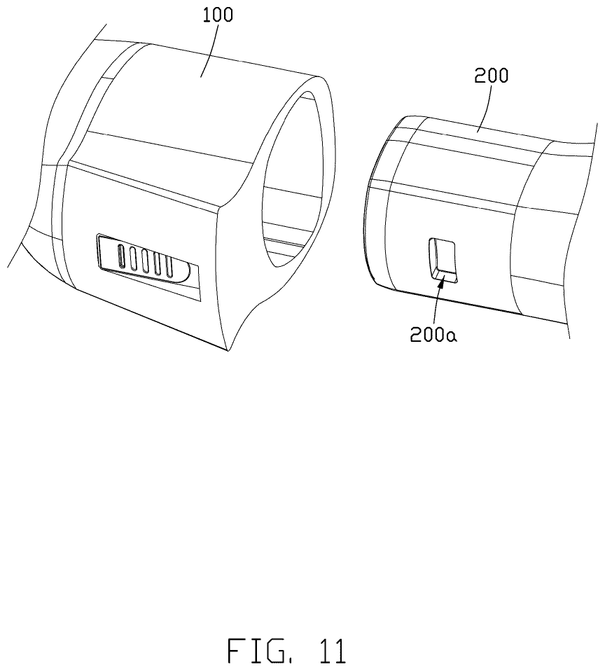

FIG. 11 shows a schematic view of a portion of the structure of the charging gun 200 and the adapter 100 of the embodiment shown in FIG. 1 in another view.

Optionally, as shown in FIG. 11, the charging gun 200 is provided with a snap-in hole 200a. In conjunction with FIG. 9, in the first locking state, the portion of the first locking part 22 that extends into the mounting cavity 11a extends into the snap-in hole 200a to prevent the charging gun 200 from being pulled out of the mounting cavity 11a.

In some embodiments, as shown in FIG. 8, the locking assembly 20 further includes a fixing bracket 23 and a first elastic member 24. The slider 21 is coupled to the fixing bracket 23 along a side of the third direction C proximate the mounting cavity 11a. The slider 21 is capable of moving along the second direction B relative to the fixed bracket 23. The side of the slider 21 along the third direction C away from the mounting cavity 11a is provided with an operation portion 212, and the operation portion 212 is exposed to the housing 10. The first elastic member 24 is provided between the first locking part 22 and the fixing bracket 23, and the first elastic member 24 is in contact with the first locking part 22 and the fixing bracket 23. The first elastic member 24 exerts an elastic force on the first locking part 22 along the third direction C away from the mounting cavity 11a.

In this way, after the second rack 33 leaves the slider 21 along the second direction B, the slider 21 and the first locking part 22 can be balanced by the elastic force of the first elastic member 24 and the force of the fixing bracket 23. The first elastic member 24 exerts an elastic force on the first locking part 22 along the third direction C away from the mounting cavity 11a, and the slider 21 is subjected to a tensile force of the fixing bracket 23 along the third direction C near the side of the mounting cavity 11a. After the second rack 33 leaves the slider 21, the first locking part 22 is able to remain in the first locking state. And by providing the operation portion 212 on the slider 21, the operation portion 212 is exposed to the housing 10, and the user is able to move the slider 21 towards the side close to the second rack and pinion 33 through the operation portion 212, in order to release the restriction of the slider 21 on the first locking part 22, so that the first locking part 22 can be able to leave the mounting cavity 11a along the third direction C under the action of the spring force of the first elastic member 24, and thus allow the charging gun 200 to be pulled out of the mounting cavity 11a. Thus, after the second rack 33 leaves the slider 21, the user is able to choose whether or not to connect the charging gun 200 to the adapter 100 as desired. When it is necessary to pull the charging gun 200 out of the adapter 100, the operation portion 212 can be pivoted toward the side close to the second rack 33 before pulling the charging gun 200 out of the adapter 100. When the charging gun 200 needs to be connected to the adapter 100, the operation portion 212 does not need to be operated.

Optionally, as shown in FIG. 10, the slider 21 is provided with a slide groove 21a, the slide groove 21a extends along the second direction B. The fixing bracket 23 is provided with a raised ground connection member 231. The connection member 231 is threaded through the slide groove 21a to secure the slider 21 along the fixing bracket 23 along the third direction C, and to enable the slider 21 to move relative to the fixing bracket 23 along the second direction B.

In some embodiments, as shown in FIG. 6 and FIG. 7, the transmission assembly 30 further includes a second transmission wheelset 34 and a third rack 35. The second transmission wheelset 34 includes a second transmission shaft 341, a second gear 342, and a second ratchet 343. The second transmission shaft 341 is rotationally coupled to the housing 10 about a second axis of rotation f. The second axis of rotation f is provided parallel to and spaced apart from the first axis of rotation e. The second gear 342 is provided on the second axis of rotation. The second gear 342 is socketed to one end of the second transmission shaft 341 and engages the second rack 33. The second ratchet 343 is socketed to one end of the second transmission shaft 341 away from the second gear 342. The third rack 35 and the second rack 33 are located on different sides of the second axis of rotation f, respectively. The third rack 35 engages the second ratchet 343. When the adapter 100 is coupled to a base 300 (see FIG. 3), the base 300 is able to drive the third rack 35 close to the mounting cavity 11a, and drive the second ratchet 343 around the second axis of rotation f. The second gear 342 drives the second rack 33 away from the locking assembly 20 in the second direction B, thereby allowing the locking assembly 20 to switch from a first locked state to a first unlocked state.

In this way, when the adapter 100 is connected to the base 300, the base 300 drives the third rack 35 close to the mounting cavity 11a. The third rack 35 drives the second ratchet 343 to rotate, thereby causing the second ratchet 343 to drive the second gear 342 to rotate through the second transmission shaft 341, which causes the second gear 342 to drive the second rack 33 to move away from the locking assembly 20 along the second direction B, so as to lift the restriction on the locking assembly 20 and enable the charging gun 200 to be unlocked from the mounting cavity 11a. Specifically, at this time, the user is able to choose whether or not to operate the operation portion 212, so that the charging gun 200 can be pulled out of the mounting cavity 11a or the charging gun 200 can be retained in the mounting cavity 11a according to the use needs.

Optionally, the transmission assembly 30 further includes a second resetting member (not shown in the drawings). The second resetting member (e.g. a spring) includes an elastic material. The second reset member is disposed between the housing 10 and the third rack 35, the second reset member is held against the housing 10 and the third rack 35, respectively. The second resetting member exerts an elastic force that moves the third rack 35 towards the side away from the mounting cavity 11a. When the base 300 is separated from the third rack 35, the third rack 35 is able to be reset towards the side away from the mounting cavity 11a by the elastic force of the second resetting member.

In some embodiments, as shown in FIG. 5 to FIG. 7, the adapter 100 further includes a second locking part 40. The second locking part 40 is movably coupled to the housing 10. The second locking part 40 has a second locking state and a second unlocking state. In the second locking state, the second locking part 40 is locked with the base 300. In the second unlocked state, the second locking part 40 is unlocked from the base 300. The transmission assembly 30 further includes a fourth rack 36. The fourth rack 36 engages the first gear 313. The fourth rack 36 is capable of engaging the second locking part 40 so that the second locking part 40 is in a position corresponding to the second locked state. When the adapter 100 is connected to the base 300, the base 300 is able to drive the third rack 35 close to the mounting cavity 11a and drive the second ratchet 343 to rotate around the second axis of rotation f. The second ratchet 343 is able to drive the second rack 35 close to the mounting cavity 11a. So that the second gear 342 drives the second rack 33 away from the locking assembly 20 in the second direction B, so that the second rack 33 drives the first gear 313 to rotate, so that the first gear 313 drives the fourth rack 36 towards the side close to the second locking part 40, and thus limits the second locking part 40 to the second locking state. In this way, when the adapter 100 is connected to the base 300, the fourth rack 36 is driven by the third rack 35, the second ratchet 343, the second transmission shaft 341, the second gear 342, the second rack 33, and the first gear 313 when driven by the base 300, in order to lock the adapter 100 with the base 300.

Optionally, as shown in FIG. 7, the first gear 313 includes two sub-gears 3131. The two sub-gears 3131 are spaced apart from each other and socketed on the first transmission shaft 311. One of the two sub-gears 3131 engages a second rack 33, and the other of the two sub-gears 3131 engages a fourth rack 36.

It will be appreciated that when the adapter 100 is connected to the base 300, the base 300 pushes the third rack 35, so that the fourth rack 36 and the second locking part 40 lock the adapter 100 to the base 300 and move the second rack 33 away from the locking assembly 20. The charging gun 200 is able to be withdrawn from the mounting cavity 11a, and the charging gun 200 is withdrawn without affecting the locking connection of the adapter 100 to the base 300. When the adapter 100 needs to be unlocked from the base 300, the charging gun 200 can be extended into the mounting cavity 11a, so that the first rack 32 moves away from the mounting cavity 11a under the drive of the charging gun 200, and drives the first ratchet 312 to rotate, so that the first ratchet 312 drives the first gear 313 to rotate, so that the first gear 313 drives the fourth rack 36 away from the second locking part 40, thus allowing the second locking part 40 to be moved away from the second locking part 40. Thereby allowing the second locking part 40 to switch from the second locking state to the second unlocking state, enabling the adapter 100 to be removed from the base 300.

In this way, before the charging gun 200 is extended into the mounting cavity 11a, the second locking part 40 is confined to the position corresponding to the second locking state, and the adapter 100 is locked to the base 300, thereby reducing the risk of loss of the adapter 100. When the charging gun 200 is extended into the mounting cavity 11a, the charging gun 200 drives the fourth rack 36 away from the second locking part 40, thereby allowing the second locking part 40 to be switched to the second unlocked state, so that the adapter 100 can be detached from the base 300, and after the charging gun 200 is extended into the mounting cavity 11a, the charging gun 200 drives the second rack 33 to restrict the locking assembly 20 to the position corresponding to the first locking state, so that the charging gun 200 is connected to the adapter 100 and locked, and the charging gun 200 is able to be connected to the charging interface of the vehicle via the adapter 100.

It should be noted that the first ratchet 312 is unidirectionally driven. Specifically, when the first rack 32 moves toward the side away from the mounting cavity 11a, the first rack 32 drives the first ratchet 312 and the first transmission shaft 311 rotate together, thereby driving the first gear 313, so that the first gear 313 rotates in the same direction as the first ratchet 312. In this way, the first gear 313 drives the second rack 33 toward the side close to the mounting cavity 11a, locks the charging gun 200 in the mounting cavity 11a, and drives the fourth rack 36 away from the second locking part 40 through the first gear 313, so that the adapter 100 can be unlocked from the base 300. And when the first rack 32 moves towards the side close to the mounting cavity 11a, the first rack 32 drives the first ratchet 312 to rotate, and the first gear 313 does not rotate. Therefore, when the adapter 100 is connected to the base 300, if the charging gun 200 is pulled out of the adapter 100, the charging gun 200 unlocks against the first rack 32, so that the first rack 32 is reset towards the side close to the mounting cavity 11a by the elastic force of the first resetting member. The first rack 32 drives the first ratchet 312 to rotate, while the first ratchet 312 does not drive other parts of the transmission assembly 30 to move. In other words, when the charging gun 200 is pulled out, the first gear 313 is stationary with respect to the housing 10, and both the second rack 33 and the fourth rack 36 are stationary with respect to the housing 10.

The second ratchet 343 is unidirectionally driven. Specifically, when the third rack 35 is moved toward the side close to the mounting cavity 11a driven by the base 300, the third rack 35 drives the second ratchet 343 to rotate, and the second ratchet 343 drives the second gear 342 to rotate through the second transmission shaft 341. In this manner, the second rack 33 is moved toward the side away from the mounting cavity 11a by the second gear 342, so that the second rack 33 is separated from the first locking part 22, and the second rack 33 is moved by the fourth rack 36 through the first gear 313, so that the fourth rack 36 is moved near the second locking part 40, so as to limit the second locking part 40 to the second locking state. And when the third rack 35 moves toward the side away from the mounting cavity 11a, the third rack 35 drives the second ratchet 343 to rotate, and the second gear 342 does not rotate. Therefore, when the adapter 100 is separated from the base 300, the third rack 35 is reset toward the side away from the mounting cavity 11a by the elastic force of the second reset member, and the third rack 35 drives the second ratchet 343 to rotate, and the second ratchet 343 does not drive the movement of other parts of the transmission assembly 30. That is, when the adapter 100 leaves the base 300, the second gear 342 is stationary with respect to the housing 10, and therefore the second rack 33 is stationary with respect to the housing 10. And the second ratchet 343 also cannot rotate driven by the second gear 342, so when the charging gun 200 is extended into the mounting cavity 11a, the second rack 33 is close to the mounting cavity 11a, the second gear 342 rotates, and both the second ratchet 343 and the third rack 35 are stationary with respect to the housing 10.

In some embodiments, as shown in FIG. 6, the second locking part 40 is capable of rotating about a third axis of rotation g relative to the housing 10. The third axis of rotation g is provided parallel to and spaced apart from the first axis of rotation e. The second locking part 40 includes a first end 41 and a second end 42, the first end 41 and the second end 42 is disposed on both sides of the third axis of rotation g, respectively. The first end 41 is used to lock the base 300 (see FIG. 3). In the second locking state, the fourth rack 36 is able to engage the second end 42 to enable the first end 41 to lock the base 300.

In this way, since both the transmission assembly 30 and the second locking part 40 are locked with the adapter 100 and the base 300 by mechanical locking means, respectively. There is no need to charge the adapter 100 or the base 300, thereby reducing the requirements for the use scenario of the base 300 and the adapter 100, and allowing the base 300 to be set up in a place where there is no power supply. Moreover, since the second locking part 40 switches between the second locking state and the second unlocking state by rotation, the locking of the first end 41 and the base 300 is easily realized without the need to set up a more special structure on the base 300, thus improving the compatibility between the adapter 100 and the base 300, and enabling the adapter 100 to be suitable for different structures of the base 300.

When the adapter 100 is connected to the base 300, the second locking part 40 is driven to switch to the second locking state, locking the adapter 100 to the base 300. At this point, the fourth rack 36 can only be driven away from the second locking part 40 by the first rack 32, the first ratchet 312, the first driveshaft 311 and the first gear 313 after the charging gun 200 is extended into the mounting cavity 11a, to allow the adapter 100 to be unlocked from the base 300. At this point, the adapter 100 and the charging gun 200 can be removed from the base 300 together, allowing the charging gun 200 to be connected to the charging port of the vehicle via the adapter 100. And when the charging gun 200 is extended into the mounting cavity 11a, the first rack 32, the first ratchet 312, the first transmission shaft 311 and the first gear 313 drive the second rack 33 to approach the first locking part 22, limit the first locking part 22 to the position corresponding to the first locking state, and lock the adapter 100 and the charging gun 200. And after the charging gun 200 and the adapter 100 are removed from the base 300, the third rack 35 is reset, and then the adapter 100 is connected to the base 300, so that the second rack 33 can be driven away from the first locking part 22 by the third rack 35, the second ratchet 343, the second transmission shaft 341 and the second gear 342. Thereby allowing the first locking part 22 to switch from the first locking state to the first unlocking state, at which time it may be selected by the user whether or not the charging gun 200 is to be stored on the base 300 together with the adapter 100. Therefore, the adapter 100 can only be locked to the base 300 or the charging gun 200, and cannot be separated from the base 300 and the adapter 100 at the same time, thus reducing the risk of theft of the adapter 100. And the adapter 100 does not need to be electrically powered when it is locked with the base 300 or the charging gun 200, which reduces the limitation on the use scenarios of the base 300 and the adapter 100, and enables the base 300 and the adapter 100 to be used in locations where there is no power supply.

In some embodiments, as shown in FIG. 3 and FIG. 4, the mounting cavity 11a extends along the second direction B and through one end of the adapter 100 to form an opening 11b. The end of the housing 10 away from the opening 11b is provided with a connection portion 121, which is used to connect to the base 300. In this way, the mounting cavity 11a and the connection portion 121 are located at both end of the housing 10. When the adapter 100 is connected to either of the base 300 and the charging gun 200, the connection of the adapter 100 to the other of them is not interfered with, thereby further improving the convenience of use of the adapter 100.

In some embodiments, as shown in FIG. 4 and FIG. 5, the housing 10 includes a first portion 11 and a second portion 12. The first portion 11 is provided with an opening 11b at an end along the second direction B. One end of the second portion 12 is connected to the end of the first portion 11 that is away from the opening 11b, and the other end of the second portion 12 is provided with a connection portion 121. The second portion 12 extends along the fourth direction D. The second portion 12 extends along the fourth direction D. The fourth direction D is perpendicular to the first direction A, and the angle between the fourth direction D and the second direction B is an acute angle. The third rack 35 is movably disposed through the housing 10 along the fourth direction D. In this way, so that the first portion 11 extends along the second direction B, the second portion 12 extends along the fourth direction D, and the angle between the fourth direction D and the second direction B is acute, so that the first portion 11 is inclinedly disposed with respect to the second portion 12, so that the adapter 100 is easy to grip. For example, the first portion 11 can be gripped during use to dock or separate the second portion 12 from the base 300. And since the extension direction of the first portion 11 is parallel to the extension direction of the second rack 33, and the extension direction of the third portion is parallel to the extension direction of the third rack 35, the row direction of the transmission assembly 30 is made to cooperate with the profile of the housing 10, so as to make the structure of the adapter 100 more compact and more effectively utilize the space within the housing 10, thereby contributing to the reduction of the size of the adapter 100.

It should be noted that some of the lines in FIG. 5, FIG. 6, FIG. 8, and FIG. 9 are shown in dashed lines to provide perspective on the internal structure.

The above embodiments are only used to illustrate the technical solutions of the present application and are not intended to be limiting, although the application has been described in detail with reference to the above preferred embodiments, a person of ordinary skill in the art should understand that modifications or equivalent substitutions can be made to the technical solutions of the present application without departing from the spirit and scope of the technical solutions of the present application.

What is claimed is:

1. An adapter comprising:
a housing provided with a mounting cavity, the mounting cavity configured for mounting a charging gun;
a locking assembly movably disposed in the housing, the locking assembly having a first locked state and a first unlocked state, wherein the charging gun is locked in the mounting cavity in the first locked state, and the charging gun is not locked in the mounting cavity in the first unlocked state; and
a transmission assembly movably disposed in the housing, the transmission assembly configured for engaging the locking assembly when the locking assembly in the first locked state,
wherein, when the charging gun is extended into the mounting cavity, the drive assembly is drivable by the charging gun to push the locking assembly to switch the locking assembly from the first unlocked state to the first locked state.

2. The adapter of claim 1, wherein the transmission assembly comprises a first transmission wheel set, a first rack and a second rack;
the first drive wheel set comprises a first transmission shaft, a first ratchet and a first gear, the first transmission shaft is rotationally connected to the housing around a first axis of rotation along a first direction, the first ratchet is socketed at an end of the first transmission shaft, and the first gear is socketed at another end of the first transmission shaft;
the first rack and the second rack are located on opposite sides of the first axis of rotation and are movably disposed in the housing along a second direction; the second direction is perpendicular to the first direction;
the first rack engages the first ratchet;
the second rack engages the first gear and is configured for engaging the locking assembly along the second direction to push the locking assembly to switch from the first unlocked state to the first locked state;
when the charging gun is extended into the mounting cavity, the charging gun is configured for driving the first rack away from the mounting cavity along the second direction and driving the first ratchet to rotate about the first axis of rotation, causing the first gear to drive the second rack closer to the mounting cavity along the second direction, thereby driving the locking assembly to switch from the first unlocked state to the first locked state.

3. The adapter of claim 2, wherein the locking assembly comprises a slider and a first locking part;
the slider is movably extended in the housing along the second direction; the second rack is configured for abutting the slider in the second direction, so that when the charging gun is extended into the mounting cavity, the second rack is configured for pushing the slider closer to the mounting cavity along the second direction; the slider is provided with a first beveled surface on an end of the slider away from the second rack, the first beveled surface is parallel to the first direction, an angle between the first beveled surface and the second direction is an acute angle;
the first locking part extends movably in the housing along a third direction, the first locking part is provided with a second beveled surface at an end along the third direction, the second beveled surface cooperates with the first beveled surface, and the first locking part is extendable into the mounting cavity at an end of the first locking part that is away from the second beveled surface along the third direction, so as to lock the charging gun inside the mounting cavity, wherein the third direction is perpendicular to the first direction and the second direction;
when the charging gun is extended into the mounting cavity, the slider is configured for driving the first locking part along the third direction into the mounting cavity to limit the charging gun to the first locking state.

4. The adapter of claim 3, wherein the locking assembly further comprises a fixing bracket and a first elastic member;
the slider is connected to the stationary bracket along a side of the third direction proximate to the mounting cavity, the slider is movable relative to the stationary bracket along the second direction, and the slider is provided with an operation portion on a side of the slider along the third direction away from the mounting cavity, the operation portion is exposed to the housing;
the first elastic member is disposed between the first locking part and the fixing bracket, the first elastic member is in contact with the first locking part and the fixing bracket respectively, and configured for exerting an elastic force on the first locking part in the third direction away from the mounting cavity.

5. The adapter of claim 2, wherein the drive assembly further comprises a second transmission wheel set and a third rack;
the second transmission wheel set comprises a second transmission shaft, a second gear and a second ratchet, the second transmission shaft is rotationally connected to the housing around a second axis of rotation, the second axis of rotation is parallel to and spaced apart from the first axis of rotation, the second gear is provided at an end of the second transmission shaft and meshing with the second rack; the second ratchet is provided at an end of the second transmission shaft away from the second gear;
the third rack and the second rack are located on different sides of the second axis of rotation, the third rack engages the second ratchet;
when the adapter is coupled to a base, the base is configured for driving the third rack to be brought proximate to the mounting cavity, and driving the second ratchet to rotate about the second axis of rotation, for causing the second gear to drive the second rack away from the locking assembly along the second direction, thereby causing the locking assembly to be switchable from the first locking state to the first unlocking state.

6. The adapter of claim 5, wherein the adapter further comprises a second locking part, the second locking part is movably connected to the housing, the second locking part has a second locked state and a second unlocked state, the second locking part is locked with the base in the second locked state,, and the second locking part is unlocked with the base in the second unlocked state;
the transmission assembly further comprises a fourth rack, the fourth rack engages the first gear, the fourth rack is configured for engaging the second locking part thereby placing the second locking part in the second locking state;
when the adapter is connected to the base, the base is configured for driving the third rack closer to the mounting cavity, and driving the second ratchet around the second axis of rotation, so that the second gear drives the second rack away from the locking component along the second direction, thereby causing the second rack to drive the first gear to rotate, causing the first gear to drive the fourth rack toward a side of the locking component closer to the second locking part side, to move the second locking part in the second locking state.

7. The adapter of claim 6, wherein the second locking part switches between the second locking state and the second unlocking state by rotating about a third axis of rotation relative to the housing, the third axis of rotation is parallel and spaced apart from the first axis of rotation;
the second locking part comprises a first end and a second end, the first end and the second end are located on respective sides of the third axis of rotation; the first end locks the base;
in the second locking state, the second end is held against the fourth rack so that the first end locks the base.

8. The adapter of claim 5, wherein the mounting cavity extends along the second direction and through an end of the adapter to form an opening;
an end of the housing away from the opening is provided with a connection portion, the connection portion is connectable to the base.

9. The adapter of claim 8, wherein the housing comprises a first portion and a second portion, the first portion is provided with the opening at an end along the second direction;
an end of the second portion is connected to an end of the first portion away from the opening, another end of the second portion is provided with the connection portion, and the second portion extends in a fourth direction, the fourth direction is perpendicular to the first direction, an angle between the fourth direction and the second direction is an acute angle;
the third rack is movably disposed through the housing in the fourth direction.

10. A charging system comprising:
a charging gun;
a base;
an adapter being capable of being mounted on the base, the adapter comprising:
a housing provided with a mounting cavity, the mounting cavity configured for mounting a charging gun;
a locking assembly movably disposed in the housing, the locking assembly having a first locked state and a first unlocked state, wherein the charging gun is locked in the mounting cavity in the first locked state, and the charging gun is not locked in the mounting cavity in the first unlocked state; and
a transmission assembly movably disposed in the housing, the transmission assembly configured for engaging the locking assembly when the locking assembly in the first locked state,
wherein, when the charging gun is extended into the mounting cavity, the drive assembly is drivable by the charging gun to push the locking assembly to switch the locking assembly from the first unlocked state to the first locked state.

11. The charging system of claim 10, wherein the transmission assembly comprises a first transmission wheel set, a first rack and a second rack;
the first drive wheel set comprises a first transmission shaft, a first ratchet and a first gear, the first transmission shaft is rotationally connected to the housing around a first axis of rotation along a first direction, the first ratchet is socketed at an end of the first transmission shaft, and the first gear is socketed at another end of the first transmission shaft;
the first rack and the second rack are located on opposite sides of the first axis of rotation and are movably disposed in the housing along a second direction; the second direction is perpendicular to the first direction;
the first rack engages the first ratchet;
the second rack engages the first gear and is configured for engaging the locking assembly along the second direction to push the locking assembly to switch from the first unlocked state to the first locked state;
when the charging gun is extended into the mounting cavity, the charging gun is configured for driving the first rack away from the mounting cavity along the second direction and driving the first ratchet to rotate about the first axis of rotation, causing the first gear to drive the second rack closer to the mounting cavity along the second direction, thereby driving the locking assembly to switch from the first unlocked state to the first locked state.

12. The charging system of claim 11, wherein the locking assembly comprises a slider and a first locking part;
the slider is movably extended in the housing along the second direction; the second rack is configured for abutting the slider in the second direction, so that when the charging gun is extended into the mounting cavity, the second rack is configured for pushing the slider closer to the mounting cavity along the second direction; the slider is provided with a first beveled surface on an end of the slider away from the second rack, the first beveled surface is parallel to the first direction, an angle between the first beveled surface and the second direction is an acute angle;
the first locking part extends movably in the housing along a third direction, the first locking part is provided with a second beveled surface at an end along the third direction, the second beveled surface cooperates with the first beveled surface, and the first locking part is extendable into the mounting cavity at an end of the first locking part that is away from the second beveled surface along the third direction, so as to lock the charging gun inside the mounting cavity, wherein the third direction is perpendicular to the first direction and the second direction;
when the charging gun is extended into the mounting cavity, the slider is configured for driving the first locking part along the third direction into the mounting cavity to limit the charging gun to the first locking state.

13. The charging system of claim 12, wherein the locking assembly further comprises a fixing bracket and a first elastic member;
the slider is connected to the stationary bracket along a side of the third direction proximate to the mounting cavity, the slider is movable relative to the stationary bracket along the second direction, and the slider is provided with an operation portion on a side of the slider along the third direction away from the mounting cavity, the operation portion is exposed to the housing;
the first elastic member is disposed between the first locking part and the fixing bracket, the first elastic member is in contact with the first locking part and the fixing bracket respectively, and configured for exerting an elastic force on the first locking part in the third direction away from the mounting cavity.

14. The charging system of claim 11, wherein the drive assembly further comprises a second transmission wheel set and a third rack;
the second transmission wheel set comprises a second transmission shaft, a second gear and a second ratchet, the second transmission shaft is rotationally connected to the housing around a second axis of rotation, the second axis of rotation is parallel to and spaced apart from the first axis of rotation, the second gear is provided at an end of the second transmission shaft and meshing with the second rack; the second ratchet is provided at an end of the second transmission shaft away from the second gear;
the third rack and the second rack are located on different sides of the second axis of rotation, the third rack engages the second ratchet;
when the adapter is coupled to a base, the base is configured for driving the third rack to be brought proximate to the mounting cavity, and driving the second ratchet to rotate about the second axis of rotation, for causing the second gear to drive the second rack away from the locking assembly along the second direction, thereby causing the locking assembly to be switchable from the first locking state to the first unlocking state.

15. The charging system of claim 14, wherein the adapter further comprises a second locking part, the second locking part is movably connected to the housing, the second locking part has a second locked state and a second unlocked state, the second locking part is locked with the base in the second locked state,, and the second locking part is unlocked with the base in the second unlocked state;
the transmission assembly further comprises a fourth rack, the fourth rack engages the first gear, the fourth rack is configured for engaging the second locking part thereby placing the second locking part in the second locking state;
when the adapter is connected to the base, the base is configured for driving the third rack closer to the mounting cavity, and driving the second ratchet around the second axis of rotation, so that the second gear drives the second rack away from the locking component along the second direction, thereby causing the second rack to drive the first gear to rotate, causing the first gear to drive the fourth rack toward a side of the locking component closer to the second locking part side, to move the second locking part in the second locking state.

16. The charging system of claim 15, wherein the second locking part switches between the second locking state and the second unlocking state by rotating about a third axis of rotation relative to the housing, the third axis of rotation is parallel and spaced apart from the first axis of rotation;
the second locking part comprises a first end and a second end, the first end and the second end are located on respective sides of the third axis of rotation; the first end locks the base;
in the second locking state, the second end is held against the fourth rack so that the first end locks the base.

17. The charging system of claim 14, wherein the mounting cavity extends along the second direction and through an end of the adapter to form an opening;
an end of the housing away from the opening is provided with a connection portion, the connection portion is connectable to the base.

18. The charging system of claim 17, wherein the housing comprises a first portion and a second portion, the first portion is provided with the opening at an end along the second direction;
an end of the second portion is connected to an end of the first portion away from the opening, another end of the second portion is provided with the connection portion, and the second portion extends in a fourth direction, the fourth direction is perpendicular to the first direction, an angle between the fourth direction and the second direction is an acute angle;
the third rack is movably disposed through the housing in the fourth direction.
